(19) United States
(12) Patent Application Publication
(10) Pub. No.: US 2009/0003959 A1
(43) Pub. Date: Jan. 1, 2009

(54) ANCHOR BOLT

(75) Inventors: Maciej GLOGOWSKI, Gdynia (PL); Sebastian KRZESZOWSKI, Kartuzy (PL); Pawel SZYMANSKI, Gdansk (PL)

Correspondence Address: MATTHIAS SCHOLL, 14781 MEMORIAL DRIVE, SUITE 1319, HOUSTON, TX, 77079, US

(73) Assignee: FLOWAIR Glogowski i Brzezinski sp.j., Gdynia (PL)

(21) Appl. No.: 12/147,527

(22) Filed: Jun. 27, 2008

(30) Foreign Application Priority Data
Jun. 27, 2007 (PL) P-382763

(51) Int. Cl. F16B 39/00

(52) U.S. Cl. 411/107

(57) ABSTRACT

An anchor bolt comprising a main body (4), a bolt head (5), at least one supporting blade (6), an internal thread (2); and an external thread (3); wherein the external thread (3) is disposed along the external surface of the main body (4); the internal thread (2) is disposed along the internal surface of the main body (4) and/or the bolt head (5); and the supporting blade is attached to the main body and the bolt head (5).

### CROSS-REFERENCE TO RELATED APPLICATIONS

Pursuant to 35 U.S.C § 119 and the Paris Convention Treaty, this application claims the benefit of Polish Patent Application No. P-382763 filed Jun. 27, 2007, the contents of which are incorporated herein by reference.

### BACKGROUND OF THE INVENTION

1. Field of the Invention

The invention relates to a fastener for joining structural elements and particularly to an anchor bolt for connecting elements made of materials that are too soft to be easily threaded.

2. Description of the Related Art

Known are fasteners and methods for joining structural elements, e.g., for joining a base (such as a device housing, a cabinet, a wall) to a second structural element. One of the methods includes treading a die-stamped cavity made, e.g., by injection molding in the base and attaching a structural element to it by means of screws. Another method includes a similar use of screws except that a nut made from a different material than the base is inserted into the base by various means. Both of these methods are, however, inadequate when a base made of a soft material is to be joined.

### SUMMARY OF THE INVENTION

In order to solve this technical problem, the invention teaches in one embodiment an anchor bolt comprising a main body (4), a bolt head (5), at least one supporting blade (6), an internal thread (2); and an external thread (3).

In a class of this embodiment, the external thread (3) is disposed along the external surface of the main body (4).

In another class of this embodiment, the internal thread (2) is disposed along the internal surface of the main body (4) and/or the bolt head (5).

In another class of this embodiment, the supporting blade is attached to the main body and/or the bolt head (5).

In another class of this embodiment, an external part of the bolt head (5) is hexagonal in shape.

In another class of this embodiment, the anchor bolt is sleeve-shaped.

In another class of this embodiment, the bolt head (5) further comprises a groove for inserting a Torx, a hex (Allen), a Phillips, or a slotted screwdriver.

In another embodiment, the invention teaches an anchor bolt comprising a main body (4) terminating at one of its ends with a bolt head (5), the main body (4) having an outside surface and having a main cavity (9) running along the entire length of the main body (4) defining an inside surface; and at least one supporting blade (6) attached to the bolt head (5) or to the main body (4) for fixing the anchor bolt in an orifice, wherein at least a portion of the outside surface and at least a portion of the inside surface are threaded.

In a class of this embodiment, the main body is shaped as a hollow cylinder.

In another class of this embodiment, the bolt head (5) is hexagonal in shape.

In another class of this embodiment, the bolt head (5) further comprises a groove for inserting a Torx, a hex (Allen), a Phillips, or a slotted screwdriver.

In another class of this embodiment, a half cross-sectional area of the anchor bolt is substantially in the shape of a letter L.

### BRIEF DESCRIPTION OF THE DRAWINGS

The invention is described hereinbelow with reference to accompanying drawings, in which:

FIG. 1 shows a bottom view of the anchor bolt; and

FIG. 2 shows a sectional view of the anchor bolt along the lines A-A in FIG. 1 partially inserted into a base, and a corresponding nut.

### DETAILED DESCRIPTION OF THE INVENTION

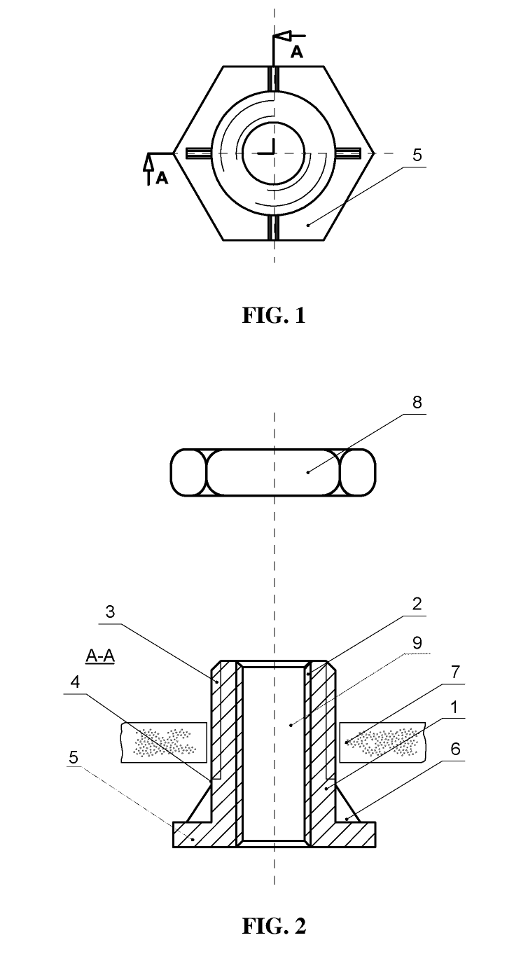

As shown in FIGS. 1-2, the anchor bolt according to the invention comprises a body 1 shaped as a sleeve having a main body 4 which terminated with a bolt head 5. An internal thread 2 is disposed along the body's 1 internal length. The internal thread 2 can be disposed along the entire length of the body or along a portion thereof. An external thread 3 is disposed along the external length of the main body 4. The external thread 3 can be disposed along the entire length of the main body 4 or along a portion thereof.

At least one supporting blade 6 joins the bottom part of the bolt head 5 (i.e., the part disposed close to the main body 4) and the main body 4. The supporting blade 6 is without limitation triangular in shape.

The bolt head 5 has advantageously an overall hexagonal shape. The front part of the bolt head 5 has advantageously a shape into which a Torx-type key, a hexagonal key, a Phillips, or a flat-head screwdriver can be inserted, in the proximity to the internal thread end.

It is required that the anchor bolt be made from a material that is harder than the base part 7, with which it is designed to be used.

After placing the anchor bolt in an orifice of the base part, the elements to be joined are pressed together by a nut 8 moving on the external thread so as to drive the supporting blade(s) 6 into the base part 7. This “anchoring” of the bolt fixes the bolt in the base part 7.

After the anchor bolt is fixed in the base part, an additional threaded detail (e.g., a different bolt) can be screwed into the internal thread of the anchor bolt. This enables, e.g., fixing different elements to the base part when the access to it is possible only from one side.

The invention features the following advantages:
1. The “anchoring” of the bolt in the base part 7 prevents the development of play and pivoting of the connection of the structural elements joined together.
2. It enables disconnection of elements at a later time without the need for disassembly of the base part (e.g. for modifications, maintenance or repairs of devices).
3. It allows for the possibility of fixing of different structural elements to the base part when the access to it is possible only from one side (e.g. during the production process of devices).

### EXAMPLE

The anchor bolt is made from polyamide with the addition of glass fibre (PA6 FG30). The body 1 of the bolt is shaped as a sleeve with an internal thread 2 along the entire length and an external thread 3 that becomes a main body 4 with a hexagonal bolt head 5. To the main body 4 and to the bottom part of the bolt head 5 there are attached four supporting blades 6, spaced symmetrically on the perimeter. After placing the anchor bolt in the orifice in the base part 7 made from ABS plastic, the bolt is pressed against this part at the other side by means of a nut 8 working on the external thread 3.

This invention is not to be limited to the specific embodiments disclosed herein and modifications for various applications and other embodiments are intended to be included within the scope of the appended claims. While this invention has been described in connection with particular examples thereof, the true scope of the invention should not be so limited since other modifications will become apparent to the skilled practitioner upon a study of the drawings, specification, and following claims.

All publications and patent applications mentioned in this specification are indicative of the level of skill of those skilled in the art to which this invention pertains. All publications and patent applications mentioned in this specification are herein incorporated by reference to the same extent as if each individual publication or patent application mentioned in this specification was specifically and individually indicated to be incorporated by reference.

What is claimed is:

1. An anchor bolt comprising
a main body (4),
a bolt head (5),
at least one supporting blade (6),
an internal thread (2); and
an external thread (3);
wherein
said external thread (3) is disposed along the external surface of said main body (4);
said internal thread (2) is disposed along the internal surface of said main body (4) and/or said bolt head (5); and
said supporting blade is attached to said main body and said bolt head (5).

2. The anchor bold of claim 1, wherein an external part of said bolt head (5) is hexagonal in shape.

3. The anchor bold of claim 1, wherein the anchor bolt is sleeve-shaped.

4. The anchor bold of claim 1, wherein said bolt head (5) further comprises a groove for inserting a Torx, a hex (Allen), a Phillips, or a slotted screwdriver.

5. An anchor bolt comprising
a main body (4) terminating at one of its ends with a bolt head (5), said main body (4) having an outside surface and having a main cavity (9) running along the entire length of the main body (4) defining an inside surface; and
at least one supporting blade (6) attached to said bolt head (5) or to said main body (4) for fixing the anchor bolt in an orifice,
wherein
at least a portion of said outside surface and at least a portion of said inside surface are threaded.

6. The anchor bolt of claim 5, wherein said main body is shaped as a hollow cylinder.

7. The anchor bolt of claim 5, wherein said bolt head (5) is hexagonal in shape.

8. The anchor bolt of claim 5, wherein said bolt head (5) further comprises a groove for inserting a Torx, a hex (Allen), a Phillips, or a slotted screwdriver.

9. The anchor bolt of claim 5, wherein a half cross-sectional area of the anchor bolt is substantially in the shape of a letter L.
